(19) United States
(12) Patent Application Publication
(10) Pub. No.: US 2021/0022382 A1
(43) Pub. Date: Jan. 28, 2021

(54) PRODUCTION OF SPICE PLANT PART PARTICLES

(71) Applicant: SYMRISE AG, Holzminden (DE)

(72) Inventors: Jens-Michael Hilmer, Holzminden (DE); Alexander Kindel, Höxter (DE); Günter Kindel, Höxter (DE)

(21) Appl. No.: 16/980,221

(22) PCT Filed: Mar. 13, 2018
(86) PCT No.: PCT/EP2018/056286

§ 371 Date: Sep. 11, 2020

(51) Int. Cl. A23L 27/14; A23L 27/10

(52) U.S. Cl. CPC A23L 27/14; A23V 2002/00; A23L 27/11; A23L 27/115

(57) ABSTRACT

The present invention is in the field of flavouring food and relates to dried fermented spice plant part particles, a process for producing the spice plant part particles according to the invention, a flavouring extract from the dried fermented spice plant part particles, the use of the dried fermented spice plant part particles as well as the aroma extract from the dried fermented spice plant part particles as well as products comprising the spice plant part particles of the invention or the aroma extract from the dried fermented spice plant part particles. The focus of the present invention is in particular to obtain spice plant part particles with a high yield of flavouring substances.

### FIELD OF THE INVENTION

The present invention is in the field of food flavouring and relates to a process for producing dried fermented spice plant part particles, dried fermented spice plant part particles thereof, flavour extracts from the dried fermented spice plant part particles, the use of the dried fermented spice plant part particles as well as the aroma extracts from the dried fermented spice plant part particles, as well as products comprising the spice plant part particles of the invention or the aroma extract from the dried fermented spice plant part particles. The focus of the present invention is in particular to obtain spice plant part particles with a high yield of flavouring substances.

### STATE OF THE ART

The production of natural flavouring substances, natural aromas and aroma extracts is becoming increasingly important from an economic point of view, particularly due to their use in industrially processed food products. Consumer demand for conscious nutrition, sustainability and authentic products continues to create a need for natural flavourings, natural flavours and extracts.

Natural flavouring substances, natural flavourings and flavouring extracts may be used as food additives. Manufacturers use them to give processed foods a more intense taste. On the other hand, parts of the aroma are lost due to further processing of food. Natural flavouring substances, aromas and aroma extracts can therefore be used to maintain the flavour intensity of a food product.

Natural flavouring substances or natural flavourings are flavouring substances or a mixture of flavouring substances obtained by physical (e.g. distillation or extraction), enzymatic or microbiological processes from plant, animal or microbiological raw materials. Both the source materials and the manufacturing processes are natural. Natural flavouring substances must occur naturally and have been detected in nature. Natural flavouring substances include natural vanillin, for example.

The aroma of the dried and fermented pods of the spice vanilla (Vanilla planifolia) is one of the highest quality and most frequently used aromas worldwide. It is used for flavouring numerous foodstuffs such as ice cream, dairy products, desserts, chocolate products, bakery products, spirits, etc. Dried and fermented vanilla beans contain about 0.4 to 2.4% of vanillin, which is the most important characteristic lead substance of natural vanilla flavour, in addition to other flavouring substances.

Usually, dried and fermented vanilla beans have a vanillin recovery of only 40 to 60%, based on the vanillin originally contained in the green vanilla beans as vanillin or glucovanillin (vanillin precursor) (see e.g. I. L. Gatfield, J.-M. Hilmer, B. Weber, F. Hammerschmidt, I. Reiß, G. Poutot, H.-J. Bertram and D. Meier, 2007, Chemical and biochemical changes occurring during the traditional Madagascan vanilla curing process, Perfumer & Flavorist, 32; 20-28).

EP 2 375 918 describes a process by which green vanilla beans are broken up and dried at a temperature of 65° C. to 120° C. to a water content of <10%. After a further crushing step and possible extraction, the enzyme (β-glucosidase) is added to convert the glucovanillin contained in the beans into vanillin. The transformation rates, i.e. the proportion of glucovanillin converted to vanillin, for this step are indicated as 80 and 85%, respectively.

U.S. Pat. No. 2,835,591 describes the production of an extract from green vanilla beans with subsequent concentration to dryness under vacuum. No information is given on the transformation rates.

CN 103981029 describes the freezing of green vanilla beans at −40° C. to −80° C., thawing at 20° C. to 30° C. and subsequent enzyme treatment with pectinase. This is followed by a solvent extraction to use the extract for perfume applications. No information is given on the transformation rates.

The MX 2007007866 discloses the freezing of vanilla beans at −1° C. to −30° C. for 24 to 96 hours. Then 0.5% ethanol is added to the vanilla beans and they are thawed at 2° C. to 8° C. for 0.5 to 6 hours. The vanilla pods are then heated to 20° C. to 45° C. for 1 to 12 hours. Finally, these vanilla pods are dried to a water content of 25 to 30% within a maximum of 10 days at a temperature of 60° C. No information is given on the transformation rates.

EP 0 555 466 describes the production of a natural vanilla flavour from broken up green vanilla beans treated with an enzyme system. These enzyme preparations should contain enzymes from the group of pectinases, cellulases, hemicellulases or cellobiases which have one or more β-glucosidase activities. At a stated initial concentration of vanillin of 0.355 g/kg of plant material, no increase in vanillin concentration is detected without the addition of enzyme (0.319 g/kg). When the enzymes are added, the vanillin content increases up to 6.5 g/kg of plant material. The reworking results in a transformation rate of 61.3%.

EP 1 613 178 describes the preparation of a vanilla extract from green vanilla beans which are subjected to an accelerated browning process, followed by extraction followed by enzyme treatment with cellulase or hemicellulase activity. For this purpose, the green vanilla beans are first frozen at a temperature of −10° C. to −30° C. and then thawed at a temperature of 2° C. to 8° C. for 0.5 to 7 days. Alternatively, accelerated browning is achieved by heating the green vanilla pods in hot water at 60 to 65° C. for 3 minutes and then storing them at 15° C. to 45° C. for 0.5 to 7 days. The browned vanilla pods are then extracted with water-ethanol solutions (20 to 80% (v/v)). This is followed by the addition of an enzyme with a cellulase activity in the range 2000 to 6000 IU/g. This is followed by cleaning with hydro-alcoholic solutions. As an example, green vanilla beans with a glucovanillin content of 1.19% (w/w) and a vanillin content of 0.1% (w/w) are used as starting material. The yield at the end of the process is 6.29 g vanillin/kg plant material (=0.629%), corresponding to 93.7% of the vanillin originally contained.

FR 2634979 concerns the production of a natural vanilla flavour from green vanilla beans. For this purpose the green vanilla beans are frozen at a temperature of −5° C. to −30° C., then heated to 30° C. to 50° C. for 2 to 4 h and then extracted. A vanillin content of up to 3.40 to 4.68%, based on the dry mass of the vanilla pod, is indicated, and a glucovanillin content of 0.04 to 1.76%, based on the dry mass of the vanilla pod, with a thawing time of 3 to 5 hours. Vanilla beans produced by the traditional method thus have a vanillin content of 2 to 2.5%. The initial contents are 11.31% glucovanillin and 0.55% vanillin, based on the dry mass of the vanilla pod. This corresponds to a potential vanillin content of the green initial vanilla beans of (11.31%*0.46+0.55%) 5.75% vanillin. The above vanillin content of 4.68% (=maximum value of the above examples) thus corresponds to a transformation rate of 81%.

Moreover, in recent years the quality of green vanilla beans has decreased considerably, which is due to the fact that the vanilla beans are harvested in an unripe state and therefore have a lower vanillin content, as fewer aromatic substances have been formed by the time of harvesting.

The aim of the present invention was to develop a process for the production of dried fermented spice plant part particles with an improved aroma substance recovery in the dried fermented spice plant part particles, i.e. a higher yield of the aroma substances contained in the spice plant part particles. In particular, it was a task of the present invention to provide a process for the production of dried fermented vanilla beans with a better recovery rate, i.e. a higher yield, of the aromatic substances contained in the vanilla beans.

### DESCRIPTION OF THE INVENTION

The present problem is solved by the subject-matter of the independent patent claims. Preferred variants are described in the dependent claims and the following description.

A first object of the present invention relates to a process for the production of dried fermented spice plant part particles, comprising the following steps:
(a) Provision of freshly harvested spice plant parts;
(b) Breaking up/crushing of the freshly harvested spice plant parts;
(c) Freezing of the broken up spice plant parts;
(d) Defrosting of the frozen broken up spice plant parts;
(e) Drying the defrosted broken up spice plant parts in a closed system to obtain dried fermented spice plant part particles; and
(f) Optionally, breaking up of the dried fermented spice plant particles.

A further object of the present invention relates to the aforementioned process for the production of dried fermented spice plant parts, in which an aroma extract is obtained from the condensate-water phase formed in the drying step (e), and which comprises the further steps:
(g) Collecting the condensate-water phase from drying step (e); and
(h) Recovery of the flavouring substances contained in the condensate-water phase, wherein the recovery of the flavouring substances from the condensate-water phase comprises the following steps:
   (i) Providing the condensed water phase containing flavouring substances;
   (ii) Provision of an adsorption material;
   (iii) Passing the condensate-water phase from step (i) through a device containing adsorption material from step (ii) with adsorption of the flavouring substances on the adsorption material;
   (iv) Provision of at least one food-grade organic solvent or a solvent mixture comprising at least one food-grade organic solvent;
   (v) desorption of the flavouring substances from the adsorption material from step (iii) with the at least one solvent or the solvent mixture from step (iv) to obtain a flavouring extract; and
   (vi) Optionally, concentration of the flavouring extract obtained from step (v).

A further object of the present invention relates to dried fermented spice plant part particles, in particular dried fermented vanilla bean/pod particles, obtainable by the method according to the invention.

In a further aspect, the present invention relates to an aroma extract, in particular a vanilla aroma extract, obtainable by the process according to the invention.

Further, the present invention relates to dried fermented vanilla bean particles wherein the yield of vanillin is at least 70% based on the total vanillin content originally present in the green unfermented vanilla beans as vanillin or vanillin precursor.

In addition, the present invention relates to a process for producing a vanilla extract from the aforementioned and in accordance with the invention dried fermented vanilla bean particles, which comprises the following steps:
(i) Providing the broken up/crushed, dried fermented vanilla bean particles;
(ii) Providing at least one food-grade organic extraction solvent or an extraction solvent mixture comprising at least one food-grade organic extraction solvent
(iii) Extraction of the vanilla bean particles with the extraction solvent or the extraction solvent mixture;
(iv) filtering the extract to remove solids; and
(v) Optionally, concentration of the vanilla extract obtained.

A further object of the present invention is a vanilla extract or are ground/milled extracted vanilla bean particles or extracted vanilla powder, obtainable by the last-mentioned process according to the invention for the production of a vanilla extract from the aforementioned dried fermented vanilla bean particles.

In a further aspect, the present invention relates to the use of the aforementioned dried fermented spice plant part particles or the aforementioned aroma extract, in particular vanilla aroma extract, or the aforementioned dried fermented vanilla pod particles or the aforementioned vanilla extract or the aforementioned ground/milled extracted vanilla pod particles or of the extracted vanilla powder for the preparation, in particular for flavouring or reconstituting the aroma, of foodstuffs, luxury foods, beverage products, semi-finished products, hygiene products, tobacco products, cosmetic or pharmaceutical products and products for animal nutrition.

Finally, the present invention relates to foodstuffs, luxury foods, beverage products, semi-finished products, hygiene products, tobacco products, cosmetic or pharmaceutical products, as well as products for animal nutrition, which comprise the aforementioned dried fermented spice plant particles or the aforementioned aroma extract, in particular vanilla aroma extract, or the aforementioned dried fermented vanilla pod particles or the aforementioned vanilla extract or the aforementioned ground/milled extracted vanilla pod particles or respectively the extracted vanilla powder, and wherein the foodstuff is selected from the group consisting of dairy products, sweets, food supplements, dietary foods and food surrogates.

### DESCRIPTION OF THE FIGURES

FIG. 1 is a flowchart with an overview of the processes according to the invention and the resulting products using freshly harvested vanilla beans as an example.

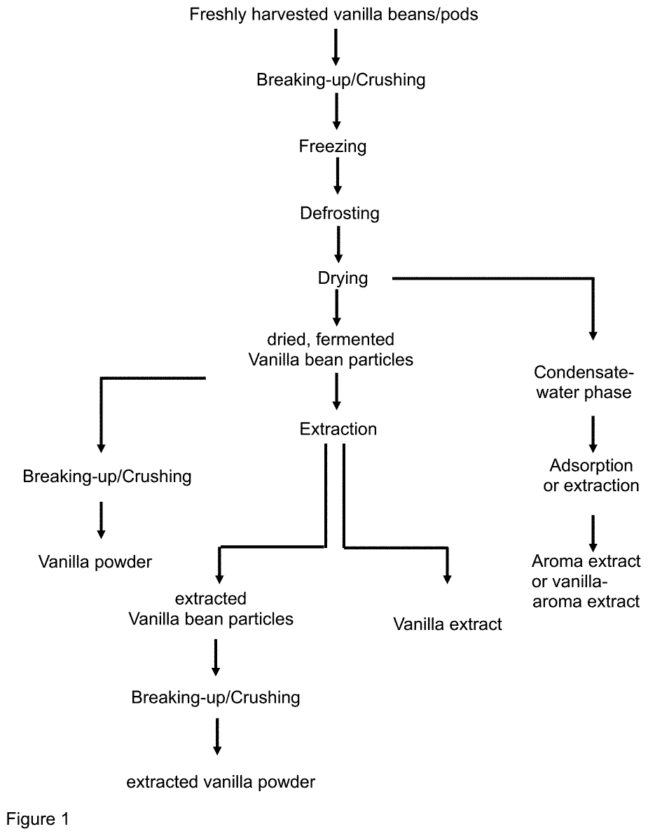

FIG. 2 is a diagram showing the sensory profiles for a state of the art vanilla extract and a vanilla extract of the invention obtained from the dried fermented vanilla bean particles of the invention.

### DETAILED DESCRIPTION OF THE INVENTION

Production of Dried Fermented Spice Plant Particles

In the process for the production of dried fermented spice plant part particles, freshly harvested spice plant parts are provided as the starting product in a first step. The starting product is not pretreated.

The term “freshly harvested” means that the spice plant parts used in the process according to the invention have not been dried, processed or fermented in any other way before use. The spice plant parts can be used immediately after harvesting or a few days later if they are stored in a dry and, if necessary, ventilated place.

Due to their natural content of flavouring and aromatic substances, spices are used as seasoning or flavour-giving ingredients in the preparation of food and beverages of all kinds. In addition, spices not only have a taste benefit, but are also used to preserve food and beverages.

By definition, the term “spice” covers only parts of plants, such as leaves (dried herbs, bay leaves, kaffir lime leaves), buds, flowers or flower parts (saffron, cloves), capers), barks (cinnamon), plant roots, rhizomes, onions (ginger, turmeric, horseradish, wasabi, kitchen onion, garlic) and fruits or seeds (nutmeg, pepper, paprika, juniper berries, vanilla, caraway, aniseed).

In the process according to the invention, the freshly harvested spice plant parts are selected from the group consisting of vanilla beans, tea leaves, clove buds, tonka beans, pepper fruits, coffee beans, cocoa tree seeds, saffron threads, ginger, turmeric, capers, aniseed, nutmeg, paprika and petals. Freshly harvested vanilla beans are particularly preferred in this process, which is in accordance with the invention.

Vanilla beans are capsule fruits (“pods”) of various species of the orchid genus Vanilla. The genus Vanilla comprises about 110 species, 15 of which provide aromatic capsules. The most important species for the production of vanilla pods is the spice vanilla (Vanilla planifolia). The spice vanilla originally comes from Mexico, but is now harvested mainly in Madagascar, Reunion and other islands of the Indian Ocean. The spice vanilla is offered in trade under the names Bourbon vanilla and Mexican vanilla. Apart from the spice vanilla, only the Tahiti vanilla (Vanilla tahitensis) and the Guadeloupe vanilla (Vanilla pompona) are of commercial importance. The Tahitian vanilla is cultivated in the South Pacific region. It is a close relative of the spice vanilla, but differs from it in aroma. The Tahitian vanilla contains less vanillin, but higher contents of other aromatic substances, which give the pods a flowery aroma. Guadeloupe vanilla originated in Central and South America and is now commercially grown in the West Indies. Its aromatic properties are similar to those of Tahiti vanilla, which is why these two varieties are used primarily in perfumery.

When ripe, the vanilla pods, which can be up to 30 cm long, have a green to yellow-green colouring. The fresh fruits do not yet have the typical dark brown colour, aroma and taste of the finished product known to consumers, i.e. the fermented vanilla beans. The oily liquid surrounding the seeds inside the capsule contains a large proportion of the aroma and flavour. In order to obtain vanilla as a highly aromatic spice, the green vanilla beans must first undergo a maturation process, i.e. fermentation, which is accompanied by browning of the vanilla beans. This process is also known in specialist circles as “curing” and the vanilla pods obtained in this way are known as “cured vanilla beans”. During the fermentation process, glucovanillin (vanillin glucoside), a precursor of vanillin (vanillin precursor), is released on the one hand, and β-glucosidases, which are endogenously present in the green vanilla beans, on the other hand. The β-glucosidases enzymatically convert the glucovanillin into vanillin by hydrolysis. Drying follows.

The freshly harvested parts of the spice plant are then, in a further step of the process according to the invention, broken up/crushed into small pieces with a size of about 10-20 mm, for example cut, chaffed, cuttered, shredded, milled/ground or chopped, by means of commercially available crushing devices known to experts in this field of technology, such as granulators or shredders. By using broken up spice plant parts, the subsequent process steps are made easier. It is clear that the subsequent maturation or fermentation of the spice plant parts is all the easier the smaller the spice plant part cut or the larger the surface area of the broken up spice plant parts, whereby of course the restrictions associated with the industrial implementation of such a process must be taken into account. Preferably the size of the broken up spice plant part particles is between 1 and 50 mm. If the degree of comminution is greater than that mentioned above, the spice plant part cuttings become too pasty and complicate the subsequent process steps such as drying the broken up spice plant parts.

After crushing or breaking up the spice plant parts, the broken up spice plant parts are packed in plastic bags, plastic sacks or other suitable containers, etc. All types of containers suitable for freezing the broken up spice plant parts are conceivable. The filled plastic bags, plastic sacks or containers are sealed and frozen. For this purpose, the broken up spice plant parts are frozen to a temperature of −1° C. to −80° C. in a commercially available freezing device intended for this purpose, for example in a refrigerator. The preferred method of freezing the minced spice plant parts is at a temperature of −10° C. to −30° C.

The length of time during which the broken up spice plant parts remain frozen has little influence on the yield of the aromatic substances. It can be one day, one week or even several months. It is preferable that the broken up spice plant parts remain frozen for a period of at least 1 day.

The speed of freezing does not necessarily have to be fast. Freezing can also be done slowly by lowering the temperature over a few hours. During the freezing process, the water in the broken up parts of the spice plant, in particular broken up vanilla pods, expands and solidifies into ice crystals. In the process, the ice crystals destroy the cell tissue and the aromatic substances or their precursors are released.

After freezing, the frozen broken up spice plant parts are defrosted. The defrosting of the broken up spice plant parts takes place over a period of usually at least 1 day. Defrosting consists of allowing the frozen broken up spice plant parts packed in the sealed plastic bags or other containers to stand at ambient temperature, i.e. outside temperature, of about 15° C. to 35° C. and to thaw slowly. Defrosting thus takes place without tempering the frozen cuttings.

Alternatively, the frozen broken up spice plant parts can be thawed in a suitable temperature control unit. There are, for example, the possibilities of defrosting in a heating cabinet, a drying cabinet, an oven or a dryer, etc.

The defrosting of the frozen broken up spice plant parts is preferably carried out in the closed plastic bags, plastic sacks or containers, i.e. under exclusion of air, so that no losses of the aromatic substances through evaporation or oxidation occur, which would lead on the one hand to a lower yield of the aromatic substances and on the other hand to a negative impairment of the sensor profile.

In the case of vanilla beans, which is a special form of the present procedure, the freshly harvested green vanilla beans are broken up immediately after harvesting or a few days later in the manner described above. The use of a cuttings makes it possible to facilitate the fermentation which takes place later. The finer the cut material, the easier the fermentation process, although in this case, too, the restrictions associated with the industrial implementation of the process according to the invention must be taken into account.

During the subsequent freezing process, ice crystals are formed from the water in the vanilla beans, which break open the cell membrane. By breaking up the cell membrane, glucovanillin on the one hand and the β-glucosidases endogenously present in the vanilla pods, which are located in different compartments of the plant cells, on the other hand, are released from the plant cells.

During the subsequent heating or thawing of the frozen broken up vanilla beans at ambient temperature of about 15° C. to 35° C., the glucovanillin is converted into vanillin, the main aromatic substance of the vanilla beans, by enzymatic hydrolysis of the released β-glucosidases, whose enzyme activity reaches its maximum in a temperature range of 25° C. to 40° C. The time required for exhaustive hydrolysis and thus maximum conversion of glucovanillin into vanillin depends on the rate of heating, the temperature at which the frozen broken up vanilla beans are thawed and the quantity of broken up vanilla beans to be thawed. The expert is familiar with these process parameters.

Frozen broken up vanilla beans are also preferably thawed in sealed plastic bags, plastic sacks or containers etc. This means under exclusion of air, so that no losses of the aroma substances through evaporation or oxidation occur, which would lead to a lower yield on the one hand and to a negative impairment of the sensor profile on the other hand.

To ensure that as little as possible of the liquid phase, i.e. plant cell liquid, and thus aromatic substances escape from the solid phase, i.e. the broken up spice plant parts, in particular the broken up vanilla pods, during thawing, the cut material in the plastic bags, plastic sacks or containers is thoroughly mixed several times during the thawing process. This mixing ensures that the liquid phase is absorbed by the solid phase. Mixing is achieved, for example, by simply turning or shaking the plastic bags, plastic sacks or containers or mixing in a suitable container of a different type. Another possibility is to collect the escaped cell liquid, i.e. “defrosting liquid”, and add it to the dry material during the subsequent drying process.

Surprisingly, it was found that particularly high yields of flavouring substances are obtained if, in a subsequent step of the process according to the invention, the thawed broken up spice plant parts, in particular broken up vanilla beans, hereinafter also referred to as cuttings to be dried, are dried in a closed system, whereby water is removed from them. Dried fermented spice plant parts, in particular dried fermented vanilla bean particles, are obtained as the end product of the drying process. The drying process of the vanilla beans in the presence of atmospheric oxygen in the closed system leads to further browning and thus to the formation of the typical dark brown color of the vanilla beans.

According to the invention, a closed system is a device or chamber designed in such a way that its interior does not allow any exchange with the environment. During the drying of the thawed broken up spice plant parts, in particular the thawed broken up vanilla pods, in such a device or chamber, neither air or oxygen is introduced into the device or chamber, nor are components of the cut material to be dried removed from the device or chamber.

The closed system prevents, for example, ingredients of the cut material to be dried, such as flavouring substances, from coming into contact with air or oxygen from the outside environment and thus being oxidatively degraded, thus reducing the yield of flavour on the one hand and changing the composition of the flavour on the other. In addition, the closed system prevents, for example, valuable aroma substances of the spice plant parts, which sublimate during drying, from escaping and thus lead to a reduction in the aroma yield in the broken up spice plant parts.

A closed system is also understood to be a device which at the same time enables the cut material to be dried quickly. According to the invention, rapid drying, in turn, is understood to be a drying process in which a faster removal of water takes place compared to drying in the air according to the state of the art.

The drying process of the thawed broken up spice plant parts, in particular the thawed broken up vanilla pods, in the process according to the invention takes place at a temperature in a range of 20° C. to 70° C., preferably at a temperature in the range of 40° C. to 60° C. and most preferably at a temperature in the range of 45° C. to 55° C.

If the drying process is carried out at a temperature higher than 70° C., thermal degradation reactions result in a significant drop in the yield of aromatic substances in the broken up spice plant parts. In the vanilla beans, a reduction in the yield of vanillin is produced at a drying temperature of more than 70° C. At temperatures lower than 40° C., drying the thawed cuttings takes a very long time and thus becomes uneconomical.

In order to ensure rapid drying of the thawed broken up spice plant parts, in particular the broken up vanilla pods, i.e. rapid removal of water, the drying is carried out in a drying device. By comparison, the drying step in state-of-the-art processes is carried out mainly at ambient temperature in the air, which—depending on the air humidity—leads to longer drying times. Longer drying times are uneconomical and adversely affect the yield of aroma substances, for example by volatilization of aroma substances, degradation of aroma substances etc.

It is advantageous to dry the defrosted broken up spice plant parts in a heat pump condensation dryer, heating cabinet, infrared dryer, circulating air oven or convection oven. Such drying devices consist of a chamber with loading and unloading equipment and allow drying in a closed system. Particularly high yields of flavouring substances are surprisingly obtained when drying is carried out in a heat pump condensation dryer.

A heat pump condensation dryer is a condensation dryer with a heat pump. With condensation dryers, the air inside the drying room is in a largely closed circuit. The initially cool circulating air is heated, which reduces the relative humidity. This dry, preheated air is then passed through the drying room and the moist spice plant parts inside. The moisture in the broken up spice plant parts, especially the broken up vanilla pods, evaporates and is absorbed by the warm air. The air cools down due to the water absorption and becomes moist. It then flows into the evaporator of the heat pump, where it is cooled to well below the dew point. As a result, the water vapour condenses as a liquid condensate-water phase on the cold surface of the evaporator and is collected in a downstream container. Surprisingly, it was found that this condensate-water phase contains not inconsiderable amounts of valuable aromatic substances from the spice plant parts, especially the vanilla beans.

Drying the thawed spice plant parts, especially the thawed vanilla beans, in a heat pump condensation dryer has proven to be particularly advantageous due to its energy efficiency. In addition, this type of drying prevents the loss of aromatic substances or vanillin that sublime during the drying process. At the same time, with the help of a heat pump condensation dryer, the condensate-water phase, which forms during the drying process and surprisingly contains valuable aromatic substances of the spice plant parts, can be continuously removed, collected, collected and fed to a further treatment for the recovery of the aromatic substances.

For drying according to the process according to the invention, the thawed broken up spice plant parts, in particular thawed broken up vanilla pods, are spread out on trays, inserts, trays or drying drawers. In the following, these trays, insertions, trays or drying drawers are referred to as “trays”. The trays may be made of various materials, such as plastics, metals, stainless steel, etc., and should be suitable for use with foodstuffs.

It has proved to be particularly advantageous if the broken up spice plant parts or broken up vanilla pods are placed on perforated plates for drying. The use of perforated plates enables the warm air in the drying chamber to circulate even better and thus to be directed past the broken up spice plant parts. This increases the drying contact, which in turn leads to faster drying.

The perforated plates have openings with a diameter of 0.5 to 10 mm, preferably openings with a diameter of 1 to 5 mm. If the diameter of the openings is too large, the cut material to be dried will fall through. Conversely, the diameter of the openings must not be too small, otherwise the air cannot circulate.

The drying time depends mainly on the amount of cuttings to be dried. The maximum duration is 48 hours, preferably 10 to 15 hours. Without air circulation (when using trays) the thawed spice plant parts are dried for at least 10 hours. With air circulation (when using perforated plates), the thawed spice plant parts are dried for at least 5 hours.

In a special version of the invention, a tray trolley is used for drying the broken up spice plant parts or the broken up vanilla pods. In a tray trolley, the plates or perforated plates are arranged in tiers one above the other. After loading, the tray trolley is moved into one of the above-mentioned heating chambers. There the hot air is directed around the broken up spice plant parts to be dried, especially broken up vanilla pods.

The arrangement of the trays on several levels in a tray trolley allows maximum contact of the hot air with the broken up spice plant parts or broken up vanilla pods and thus faster drying of the broken up spice plant parts, especially the broken up vanilla pods. By reducing the drying time, oxidation or loss of the aromatic substances of the broken up spice plant parts or the broken up vanilla pods can be prevented or at least reduced.

The use of a rack trolley during the drying step also has the advantage that large quantities of cuttings to be dried can be dried. A standard tray trolley, for example, has a capacity of several 100 kg of the plant material to be dried, for example in the range of 100 to 1,000 kg/dryer at the start of the drying process, divided into 10 to 100 trays with a total area of several m², for example 5 out of 50 m².

The drying time in a trolley with the above dimensions is at least 5 hours, preferably 10 to 20 hours.

In order to accelerate drying, the cut material to be dried is occasionally turned over and redistributed on the trays so that moist spice plant parts, in particular broken up vanilla pods, can be brought to the surface with improved contact with the drying air and can thus again better release water and dry.

During the drying process, moisture is removed from the broken up spice plant parts, in particular the broken up vanilla pods, to a content of approximately 10 to 30% by weight, in particular 20% by weight.

The broken up spice plant parts, in particular broken up vanilla beans, have a dry matter or dry matter content of 70 to 90% by weight after drying is complete, in particular a dry matter or dry substance content of 80% by weight.

If the dry matter content is higher, the dried broken up spice plant parts, especially the dried broken up vanilla pods, become too dry and brittle and lose their aroma. At a moisture content of more than 30% by weight, there is an increased risk of microbiological spoilage and the formation of sensorily undesirable degradation products.

In a further process step, the dried fermented spice plant particles or dried fermented vanilla pod particles obtained after drying are further broken up if necessary and depending on their further use. Further comminution is achieved by cutting, chipping, cutting, shredding, grinding or chopping.

The most advantageous process has been found to be the process according to the invention for the production of dried fermented vanilla bean particles using freshly harvested green vanilla beans as the starting product. In such a process, the recovery of vanillin, i.e. the yield of vanillin from steps (a) to (f)≥is 70%, based on the vanillin content originally present in the green unfermented vanilla beans as total vanillin (vanillin plus vanillin precursor). Preferably, the vanillin yield from steps (a) to (f)≥is 80%, based on the total vanillin content originally present in the green unfermented vanilla beans as vanillin precursor and vanillin.

Green vanilla beans were cut into small pieces with a chopper, filled into plastic bags and then frozen at −15° C. to −30° C. After a few days, the plastic bags were removed from the freezer and thawed open in the shade at ambient temperature within 2 to 3 days. The defrosted broken up vanilla beans were exhaustively extracted with ethanol and the ethanol extract obtained was analysed by HPLC without further dilution. Analysis of the thawed broken up vanilla beans by HPLC (high pressure liquid chromatography) showed a vanillin content of 0.61% vanillin, based on the dry matter content of 15% of the green vanilla beans used. The vanillin content of the thawed broken up vanilla beans thus corresponds to 4.07 g per 100 g dry matter of the green vanilla beans used (4.07%). Subsequent drying was carried out in a drying cabinet at a drying temperature of 50° C. After a drying time of 21 hours (using a sieve as a receiver vessel (with air circulation)) or after a drying time of 43 hours (using an aluminium tray as a receiver vessel (without air circulation), a dry matter content of 80% was achieved. After drying, the dry fermented vanilla bean particles showed a typical dark brown colour. The vanillin content was now 2.7%, based on a dry substance content (DM) of 80%, i.e. a vanillin content of 3.4%, based on a dry substance content (DM) of 100%. The vanillin yield (vanillin recovery) was therefore 84%.

Preparation of a Flavour Extract from the Condensed Water Phase

In a further preferred design, the process for the production of dried fermented spice plant particles comprises the additional steps

(g) collecting the condensate-water phase from drying step (e); and
(h) Recovery of the flavouring substances contained in the condensate-water phase.

As already described above, the condensate-water phase, which is separated during the drying of the broken up thawed spice plant parts or the broken up thawed vanilla pods, is captured in the drying device and collected.

Surprisingly, it was found that the condensate-water phase contains a not inconsiderable amount of valuable aromatic substances originating from the broken up parts of the spice plants, especially from the broken up vanilla beans. These flavouring substances are recovered in a subsequent process.

The recovery of the flavouring substances contained in the condensate-water phase from the broken up spice plant parts, in particular the broken up vanilla pods, comprises the following steps:

(i) Provision of the condensate-water phase containing the flavouring substances;
(ii) Provision of an adsorption material;
(iii) Passing the condensate-water phase from step (i) through a device containing adsorption material from step (ii) with adsorption of the flavouring substances on the adsorption material;
(iv) Provision of at least one food-grade organic solvent or a solvent mixture comprising at least one food-grade organic solvent;
(v) Desorption of the flavouring substances from the adsorption material from step (iii) with the at least one organic solvent or the solvent mixture from step (iv) to obtain a flavouring extract; and
(vi) Optionally, concentration of the flavouring extract obtained from step (v).

The recovery of flavouring substances from the collected condensate-water phase from drying step (e) of the process described above is adsorptive. Such adsorption processes, in which flavouring substances are recovered adsorptively from aqueous solutions, are known from the state of the art and are described, for example, in EP 2 075 320 A1, in particular in sections [0042] to [0055], the disclosure of which is taken over in full in the present application by reference.

For the recovery of the flavouring substances, in a first step the condensate-water phase containing the flavouring substances is provided. The condensate-water phase is an aqueous solution, emulsion or suspension which has a water content of at least 95% relative to the total volume of the condensate-water phase. The flavouring substances contained in the condensate-water phase comprise at least one or more flavouring substance(s) which originate from the starting material, i.e. the freshly harvested spice plant parts, or were present there as precursors. The proportion of the at least one flavouring substance(s) in the condensate-water phase is up to 10%, based on the content of flavouring substance(s) or vanillin content of 100% of the starting material used (freshly harvested spice plant parts, in particular freshly harvested vanilla beans).

In a further step of the process according to the invention, an adsorption material is provided. According to the present invention, in step (ii) all suitable adsorption materials which are usually available for an adsorption/desorption process can be used.

Preferred adsorption materials are polystyrenes crosslinked in various ways, preferably copolymers of ethylvinylbenzene and divinylbenzene, vinylpyrrolidone and divinylbenzene, vinylpyridine and divinylbenzene, styrene and divinylbenzene, but also other polymers, such as preferably polyaromatics, polystyrenes, poly(meth)acrylates, polypropylenes, polyesters, polytetrafluoroethylene.

The adsorption material is placed in a device suitable for carrying out the adsorption. Such a device is usually a glass or stainless-steel column, the internal volume usually ranging from a few millilitres to a thousand litres, preferably from 1 to 500 litres, more preferably from 2 to 400 litres.

In a further step of the process according to the invention, the condensate-water phase containing the flavouring substances is passed through the device with the adsorption material. During this process, the flavouring substances absorb on the adsorption material.

In a preferred design of the process according to the invention, the flow velocity of the condensate-water phase is adjusted in the range of 0.1 to 2.5 cm/s during the adsorption process. The parameter of the flow velocity is jointly responsible for the degree of adsorption of the flavouring substances. Preferably the flow velocity is in the range of 0.2 to 1.5 cm/s, further preferably in the range of 0.4 to 0.9 cm/s.

In another preferred design of the present process according to the invention, the temperature of the condensate-water phase during the adsorption process is in the range of 10° C. to 60° C. The parameter of temperature is also jointly responsible for the degree of adsorption of the aromatic substances. Furthermore, a temperature range of 15° C. to 40° C. is preferred, and a temperature range of 20° C. to 30° C. is particularly preferred.

In another preferred design, the back pressure inside the adsorption device during the adsorption process is in the range of 0.1 to 4.0 bar. The back pressure within the adsorption device is the pressure created by the resistance of the adsorbent material when the condensate-water phase is pumped through the adsorption device. Preferably, a back pressure in the range of 0.1 to 2.0 bar is preferred, especially from 0.1 to 0.9 bar.

For the subsequent desorption of the flavouring substances from the adsorption material in step (v) of the process according to the invention, at least one food-grade organic solvent or a solvent mixture comprising at least one food grade organic solvent is provided.

Solvents suitable for use with food are those solvents that are suitable for consumption and are legally permitted for use in the preparation of food. Suitable solvents are listed, for example, in Directive 2009/32/EC of the European Parliament and Council.

Preference is given to the desorption of the flavouring substances from the adsorption material according to step (v) of the process according to the invention to at least one food-grade organic solvent selected from the group consisting of methanol, ethanol, propanol, isopropanol, ethyl acetate, diacetin, triacetin, liquid carbon dioxide, food grade chlorofluorocarbons and plant triglycerides or mixtures thereof. Ethanol, propanol, isopropanol, ethyl acetate, diacetin and triacetin or mixtures thereof are preferred. Ethanol or isopropanol or their mixtures are also preferred. Most preferably, ethanol is used as solvent in step (v) of the process according to the invention.

Ethanol is most preferred because the resulting aroma extract can be used without distilling off the solvent and thus without exposure to temperature. This prevents losses of aroma substances in the aroma extract due to thermal degradation. Furthermore, ethanol prevents microbial spoilage of the aroma extract, even if the aroma extract is stored at a later date.

The term “mixture of solvents” covers all conceivable combinations of the organic solvents listed above with one another. In addition, the term shall also include mixtures of at least one of the above-mentioned organic solvents with at least one other organic solvent suitable for use with foodstuffs and listed in the above-mentioned Directive 2009/32/EC or the mixture of at least one of the above-mentioned organic solvents with water.

In such solvent mixtures, the mixing ratio of the at least one organic solvent to a further organic solvent suitable for foodstuffs or water is in the range of 98:2 to 20:80; preferably the mixing ratio is 96:4, for example 96% ethanol.

In the following, preferred designs with regard to the desorption process according to the invention are presented.

A preferred design of the process according to the invention is characterized in that the flow velocity of the at least one solvent during the desorption process is in the range of 1 to 15 cm/min.

In another preferred configuration of the process according to the invention, the temperature of the at least one solvent during the desorption process is in the range of 0° C. to 60° C. The parameter of the temperature is jointly responsible for the degree of desorption of the flavouring substances. Furthermore, a temperature range of 10° C. to 40° C. is preferred, and a temperature range of 15° C. to 40° C. is particularly preferred.

In a further preferred design, the process according to the invention is characterized by the fact that the back pressure within the apparatus during the desorption process is in the range of 0.01 to 2.0 bar. The back pressure within the apparatus is the pressure which is generated by the resistance of the adsorption material when the at least one solvent is pumped through the apparatus. A back pressure in the range of 0.01 to 1.5 bar is preferred, especially preferably 0.01 to 1.0 bar.

If necessary and depending on the further use, the flavouring extract obtained from step (v), in particular the vanilla flavouring extract obtained, may be concentrated, if necessary, by methods known from the state of the art, for example by distilling off the at least one organic solvent used for the desorption of the flavouring substances.

The process according to the invention is characterized in that the yield of aroma substances from the condensate-water phase is 0.1 to 20%, in particular 1 to 10%, based on the content of aroma substances originally contained in the freshly harvested spice plant parts. When freshly harvested vanilla beans are used as starting material in the process according to the invention, the yield of aroma substances from the condensate-water phase is 0.1 to 20%, in particular 1 to 10%, based on the content of aroma substances and their precursors originally present in the green unfermented vanilla beans or the total vanillin content present as vanillin precursor and vanillin.

By coupling the process according to the invention with the adsorptive enrichment of the flavouring substances contained in the condensate-water phase, the yield of flavouring substances can be further increased, whereby an almost complete recovery of the flavouring substances ≥75%, in particular ≥80 to 100%, is possible.

As an alternative to the recovery of the flavouring substances from the condensate-water phase using the adsorptive process described above, the recovery of the flavouring substances from the condensate-water phase can also be carried out by filtration. Such a process, in which flavouring substances are separated from highly diluted aqueous solutions by osmosis using an aquaporin filter, is known from the state of the art and is described, for example, in PCT/EP2017/78735, in particular in sections [0014] to [0066], the disclosure of which is taken over in full in the present application by reference. The filtration of the condensate-water phase results in an aroma concentrate, in particular a vanilla aroma concentrate, when freshly harvested vanilla beans are used as starting material.

Furthermore, the condensate-water phase containing flavouring substances can also be concentrated by conventional processes such as distillation, freeze-drying, membrane filtration or osmosis using a membrane to obtain a flavour concentrate.

All modifications to the method described above include the design using freshly harvested green vanilla beans as the starting product.

The present invention also relates to dried fermented spice plant part particles obtainable by the process described above. In a preferred embodiment, the present invention relates to dried fermented vanilla pod particles obtainable by the method described above.

The dried fermented spice plant particles, in particular vanilla bean particles, produced by the process according to the invention, have a dry matter content of 70 to 90%, preferably a dry matter content of 75 to 85%.

The present invention also concerns a flavouring extract obtainable by the process described above. In a preferred embodiment, the present invention relates to a flavouring extract comprising vanillin, obtainable by the process described above, in which green vanilla beans were used as the starting product, hereinafter referred to as “vanilla flavouring extract”.

When green vanilla beans are used as the starting product, vanillin is by far the most important and quantitatively largest flavoring agent in the flavor extract produced from the condensate-water phase. However, the aroma extract also contains other aroma substances typically found in vanilla in smaller quantities, such as p-hydroxybenzaldehyde, p-hydroxybenzoic acid, vanillic acid.

The present invention also relates to dried fermented vanilla bean particles characterized in that the yield of vanillin is at least 70%, in particular 80-90%, based on the total vanillin content originally present in the green unfermented vanilla beans as vanillin precursor or vanillin. The dried fermented vanilla bean particles are further characterized in that they comprise a vanillin content of at least 1.5%, preferably at least 2.0%, vanillin, based on the dry substance content.

The dried fermented vanilla bean particles according to the invention are used either directly, possibly with further comminution, for example by grinding, or are used in a process for the production of a vanilla extract as described below.

Preparation of a Vanilla Extract from the Vanilla Bean Particles

The present experience therefore also concerns a process for the preparation of a vanilla extract from the above-mentioned dried fermented vanilla bean particles, which comprises the following steps:
(i) Providing the broken up, dried fermented vanilla bean particles;
(ii) Providing at least one food-grade organic extraction solvent or an extraction solvent mixture comprising at least one food-grade organic extraction solvent
(iii) Extraction of the vanilla bean particles with the extraction solvent or the extraction solvent mixture;
(iv) Filtering the extract to remove solids; and
(v) Optionally, concentration of the vanilla extract obtained.

The production of a vanilla extract from dried fermented vanilla bean particles is known from the state of the art. In particular, processes are known from the state of the art in which a vanilla extract is produced from dried fermented vanilla beans by extraction with a food-grade organic solvent. Such a process is described, for example, in WO 2004/091316 A1, in particular page 2, the disclosure of which is incorporated in full in the present application by reference.

To produce a vanilla extract, the dry fermented vanilla bean particles are, if necessary, further broken up, e.g. ground, using conventional crushing methods known to experts in this field of technology using granulators or shredders. The use of broken up vanilla beans facilitates the subsequent extraction. It is clear that the smaller the ground vanilla beans or the larger the surface area of the broken up vanilla bean pieces, the easier it is to extract the vanilla beans, bearing in mind, of course, the limitations associated with the industrial implementation of such a process. Preferably, the size of the broken up vanilla bean particles is between 0.1 and 40 mm. If the degree of comminution is greater than that mentioned above, the vanilla bean grist becomes too pasty and makes subsequent process steps such as filtration (clogging of the sieves) or distillation (boiling delay) more difficult.

A pre-treatment of the broken up vanilla bean pieces is not necessary in the process according to the invention.

After crushing, the broken up vanilla beans are transferred to a standard extractor or press for subsequent extraction. During the extraction process, the extraction material is moved in order to increase the contact between the extraction material and the extraction solvent or the extraction solvent mixture and thus increase the efficiency of the extraction process.

In a further step of the process according to the invention, the flavourings of the broken up vanilla beans are extracted with an extraction solvent or an extraction solvent mixture.

For the extraction of the flavouring substances from the dried fermented vanilla bean particles according to step (i) of the process according to the invention, at least one food-grade organic extraction solvent according to Directive 2009/32/EC of the European Parliament and of the Council or an extraction solvent mixture comprising at least one food grade organic extraction solvent is used. The organic extraction solvent is preferably selected from the group consisting of methanol, ethanol, propanol, isopropanol, ethyl acetate, liquid carbon dioxide and plant triglycerides or mixtures thereof. Preferably ethanol, propanol, isopropanol, ethyl acetate or mixtures thereof are used. Ethanol or isopropanol or mixtures thereof are also preferred. Most preferred is ethanol as extraction solvent.

Ethanol is most preferred because the resulting vanilla extract can be used without distilling off the solvent and thus without exposure to temperature. This prevents losses of aroma substances in the vanilla extract due to thermal degradation. As a solvent, ethanol stabilizes waxes and other lipophilic substances which would cause solubility problems and precipitate without the use of a solubilizer. Furthermore, ethanol contributes to the microbiological stability of the vanilla extract.

The term “extraction-solvent mixture” according to the present invention comprises all conceivable combinations of the extraction solvents listed above with each other. In addition, the term “extraction-solvent mixture” according to the present invention comprises at least one of the above mentioned extraction solvents in mixture with at least one other organic solvent according to Directive 2009/32/EC of the European Parliament and of the Council, which is permitted in the production of foodstuffs. Furthermore, the term “extraction solvent” includes at least one of the above-mentioned extraction solvents in combination with water.

When an extraction solvent mixture as defined above is used for extraction, the mixing ratio of the at least one food grade organic extraction solvent to the other organic solvent is in the range of 1:99 to 99:1; when the at least one food grade organic extraction solvent is used in admixture with water, the mixing ratio of the organic extraction solvent to water is in the range of 96:4 to 40:60, preferably in a ratio of 80:20 to 85:15.

Preferably, the extraction solvents mentioned above are used undiluted, i.e. without secondary solvents.

In the extraction step according to the process according to the invention, the ratio of the amount of extraction solvent or extraction solvent mixture to the amount of vanilla beans used is decisive for an exhaustive extraction. With a high quantity of vanilla beans and a small quantity of extraction solvent or extraction solvent mixture, the extraction solvent or extraction solvent mixture quickly becomes saturated, so that the valuable ingredients cannot be completely extracted from the broken up vanilla beans.

Conversely, too large a quantity of extraction solvent or extraction solvent mixture is not desirable, as the extract is then very diluted and its aroma no longer emerges. In addition, the evaporation of large quantities of extraction solvent or extraction solvent mixture is uneconomical from a procedural point of view. Large quantities of extraction solvents or extraction solvent mixture are also accompanied by longer evaporation times, which can lead to losses of valuable components (e.g. through degradation or due to their volatility, such as sublimation in the case of vanillin) or the formation of interfering components (e.g. through oxidation) in the vanilla extract and thus to changes in the sensory profile of the vanilla extract obtained from it.

The extraction solvent or extraction solvent mixture is therefore used in excess of the amount of broken up vanilla beans in the process according to the invention to ensure exhaustive extraction. Preferably, the extraction solvent or extraction solvent mixture is added to the amount of broken up vanilla beans in a range of 1:1 (w/w) to 40:1 (w/w). The most preferred ratio of extraction solvent or extraction solvent mixture to the amount of broken up vanilla beans is 2:1 (w/w) to 10:1 (w/w).

In the process according to the invention, the extraction of the broken up vanilla beans is carried out in such a way that the extraction solvent or the extraction solvent mixture is renewed at least twice, but not more than five times. The extraction of the broken up vanilla beans is preferably performed in such a way that the extraction solvent or the extraction solvent mixture is renewed consecutively at least twice, but not more than four times. Most preferably, the extraction solvent or the extraction solvent mixture is renewed consecutively at least three times. Consecutive extraction ensures an exhaustive extraction of the flavouring substances from the broken up vanilla bean particles and thus maximizes the yield of flavouring substances.

After each extraction step, the raw extract obtained is decanted from the extraction material and the fractions of raw extract obtained from several consecutive extraction steps are combined into one raw extract.

Extraction is normally carried out in a temperature range of 25 to 80° C., preferably in a temperature range of 50 to 70° C. and for a period of 100 to 600 minutes, preferably at a temperature of 60 to 70° C. and for 4 to 8 hours in a suitable extraction apparatus.

After exhaustive extraction of the dried fermented vanilla bean particles, the vanilla extract thus obtained is filtered to remove solid, non-dissolvable components, which are mainly the extracted fermented vanilla bean particles, from the raw extract. The filtration is preferably carried out through a bag filter or a plate filter (0.01 to 10 μm) to obtain a vanilla extract.

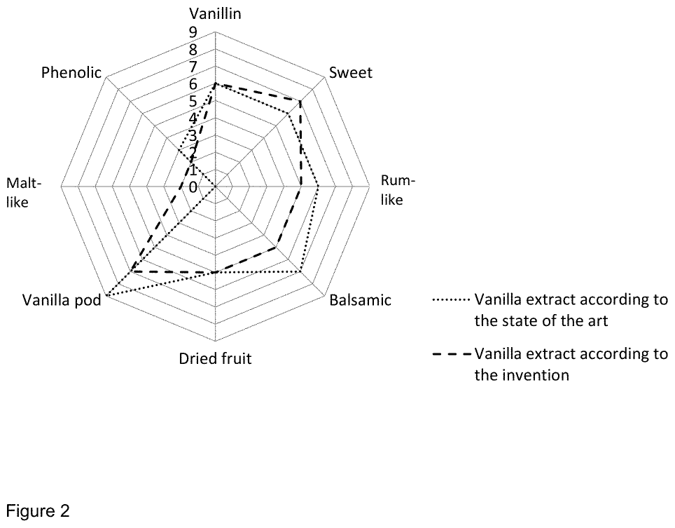

The inventive vanilla extract described above has a sensory profile which is shown in FIG. 2 in comparison with the sensory profile of a vanilla extract obtained from vanilla beans produced by a state of the art process. The comparative extract has been prepared in the same way as described in point 5 of the following examples. As can be clearly seen from FIG. 2, the sensory profile in the parameters “Vanillin”, “Sweet”, “Rum-like”, “Balsamic”, “Dried fruit”, “Vanilla bean”, “Malt-like” and “Phenolic” on a scale of 0 to 10 of a conventional panel profile of such a vanilla extract shows the phenolic notes to be at least 1 point lower and the balsamic notes and the vanilla bean notes to be at least 2 points lower. Thus, the extracts according to the invention are particularly suitable for optimally presenting particularly sensitive aroma notes such as caramel, butter or cream in aroma creations.

To create a sensory profile, the descriptive terms (descriptors) are first collected in the panel, whereby the lists of terms are structured, similar terms are combined and hedonic attributes are eliminated. The assessment of the intensity of the descriptors on a scale of 1-10 is carried out by at least ten trained test persons. The samples are coded, tasted in a randomised sequence and excluding disturbing factors such as colour, noise and foreign odours in the sensory room. The final result is determined by summing the individual results and then forming the arithmetic mean and is presented graphically in the form of a network diagram.

The filtered extracted fermented vanilla bean particles are dried in a further process step and, if necessary, ground to obtain ground extracted vanilla bean particles or extracted vanilla powder.

The present invention thus also concerns a vanilla extract obtainable by the method described above.

In a special version, the vanilla extract prepared from the dried fermented vanilla bean particles as described above is combined with the aroma extract prepared from the condensed water phase in step (v) or step (iv) of the process according to the invention.

Surprisingly, the combination of both extracts has been shown to yield a vanilla extract in which the yield of vanillin is at least 60%, preferably at least 70-100%, based on the total vanillin content originally present in the green unfermented vanilla beans as glucovanillin (vanillin precursor) and vanillin.

These yields mean that during the process according to the invention, starting from the freshly harvested vanilla beans used until the extracts are obtained, there is very little loss of valuable aroma substances, in particular vanilla aroma substances, and the recovery, i.e. the yield of valuable aroma substances, i.e. vanillin, from the starting product (freshly harvested green unfermented vanilla beans) to the end product is high, i.e. is at least 60%, preferably at least 70%, based on the total vanillin content originally present in the green unfermented vanilla beans as glucovanillin (vanillin precursor) and vanillin.

The present invention also relates to ground extracted vanilla bean particles obtained by extraction of the dried fermented vanilla bean particles as described above.

The procedure according to the present invention has the following advantages over prior art procedures:
The process does not require temperature control during thawing.
The combination with a very gentle drying process is independent of local weather conditions in the country of production.
Drying is carried out in a closed system, which minimizes the energy required.
The process does not require the addition of enzymes such as glucosidases or pectinases.
The yield of vanillin is at least 70%.
The process can be coupled with an adsorptive enrichment of the flavouring substances contained in the condensate-water phase, which is formed during drying, in order to further increase the yield of flavouring substances.
The process enables an almost complete recovery of the aroma substances.
The vanilla extract obtained has a typical sensory profile of a vanilla extract in which the phenolic notes are less pronounced than in a vanilla extract produced using the state of the art.

The dried fermented spice plant part particles described above according to the invention, especially the dried fermented vanilla pod particles, the aroma extracts, especially the vanilla extract, or the ground extracted vanilla pod particles or the extracted vanilla powder can be used for the production, in particular for flavouring or reconstituting the aroma, of foodstuffs, luxury foods, beverage products, semi-finished products, hygiene products, tobacco products, cosmetic or pharmaceutical products and products for animal nutrition.

A further aspect of the present invention are therefore also food, luxury food, beverage products, semi-finished products, hygiene products, tobacco products, cosmetic or pharmaceutical products as well as products for animal nutrition, which contain the above described dried fermented spice plant particles according to the invention, in particular the dried fermented vanilla bean particles, the aroma extracts, in particular the vanilla extract or the ground extracted vanilla bean particles or the extracted vanilla powder. The foodstuffs to which the dried fermented spice plant part particles, in particular the dried fermented vanilla bean particles, the aroma extracts, in particular the vanilla extract or the ground extracted vanilla bean particles or the extracted vanilla powder are added according to the invention are preferably selected from the group consisting of dairy products, sweets, food supplements, dietetic foodstuffs and food surrogates, without being limited thereto.

### Examples

The procedures according to the present invention and the products obtained with it are now described in more detail by means of the following examples.

1. Breaking Up, Freezing and Thawing the Vanilla Beans

1,000 g of green, freshly picked vanilla beans were broken up with a commercial crusher (e.g. “Moulinex”). These broken up vanilla pods were then filled into a plastic bag and frozen at −18° C. After 1 day at −18° C., this bag frozen with the broken up vanilla pods was removed from the refrigerator and thawed at room temperature (20° C.).

Samples were analysed by HPLC (high pressure liquid chromatography) both before freezing and after thawing.

Results:

| | Glucovanillin | Vanillin | Total vanillin |
|---|---|---|---|
| Sample | (%) | (%) | (%) |
| Before | 0.29 | 0.17 | 0.31 |
| freezing | | | |
| After | 0.01 | 0.35 | 0.35 |
| thawing | | | |

2. Drying the Vanilla Beans in the Drying Cabinet

1,000 g of the vanilla pod particles thawed according to example 1 were placed on a sieve and dried in a standard drying oven (e.g. Memmert drying oven) at 50° C. The drying time was 12 or 21 hours.

Samples were analyzed by HPLC both before and after drying.

Results:

| | | Dry | Vanillin | Yield of total |
|---|---|---|---|---|
| | | substance | (%) | vanillin (%) |
| | Vanillin | (dry matter) | (on dry | (based on |
| Sample | (%) | (%) | matter) | drying step) |
| experiment 1: | 0.52 | 17 | 3.06 | — |
| Before the | | | | |
| Drying | | | | |
| experiment 1: | 2.49 | 85 | 2.94 | 96 |
| After 12 | | | | |
| Hours Drying | | | | |
| experiment | 0.61 | 15 | 4.07 | — |
| two: | | | | |
| Before the | | | | |
| Drying | | | | |
| experiment | 2.72 | 80 | 3.40 | 84 |
| two: | | | | |
| After 21 | | | | |
| Hours Drying | | | | |

3. Drying the Vanilla Pods in the Heat Pump Condensation Dryer

500 g of the vanilla pod particles thawed according to example 1 were dried on a perforated sieve bottom in a heat pump condensation dryer (e.g. Harter's laboratory heat pump condensation dryer) at 50° C. The drying time was 9 hours. 90 g dried vanilla bean particles and 287 g condensate-water phase were obtained.

The condensate water was collected separately and further processed in a subsequent step.

Both before and after drying, samples are analyzed by HPLC.

Results:

| | | | | | Total | Yield of |
|---|---|---|---|---|---|---|
| | | | | Dry | vanillin (%) | total |
| | Gluco- | | Total | substance | (based on | vanillin (%) |
| | vanillin | Vanillin | vanillin | (dry matter) | dry | (related to |
| Sample | [%] | (%) | (%) | (%) | substance) | drying step) |
| Vanilla beans | 0.424 | 0.324 | 0.528 | 16.1 | 3.27 | — |
| before the | | | | | | |
| Drying | | | | | | |
| Vanilla beans | 1.476 | 1.877 | 2.585 | 90.5 | 2.84 | 87 |
| after the | | | | | | |
| Drying | | | | | | |
| Condensate- | — | 0.08 | 0.08 | — | — | 9 |
| water phase | | | | | | |

4. Preparation of a Flavouring Extract

896 kg of a condensate-water phase produced analogously in the heat pump condensation dryer were pumped through an adsorber column containing a suitable adsorber resin (see EP 2 075 320). The adsorber column had a useful volume of 20 I. After the loading process, the loaded adsorber column was desorbed by adding 30 I ethanol (96%). The first 7 kg (=pre-run) were discarded, the following 20 kg aroma extract was collected as product.

Samples from both the condensate-water phase and the aroma extract were analyzed by H PLC.

Results:

| | Ground | Vanillin | Vanillin | Yield |
|---|---|---|---|---|
| Sample | (kg) | (%) | (kg) | (%) |
| Condensate- | 896 | 0.056 | 0.50 | — |
| water phase | | | | |
| Aroma extract | 20 | 2.522 | 0.50 | 100 |

5. Preparing a Vanilla Extract

1,000 g of the vanilla bean particles dried in the heat pump condensation dryer were placed in a glass flask and extracted with 1.500 ml 45% (v/v) ethanol at 65° C. for 4 hours with stirring. After extraction, the solid particles were filtered off. The extract is concentrated to a volume of 1 litre at the rotary evaporator (Heidolph Rotavapor R-300, 100 mbar, 65° C.).

Samples are analysed by HPLC both before and after extraction.

Results:

| | Quantity | Vanillin | Yield vanillin |
|---|---|---|---|
| Sample | (g) | (%) | (%) |
| Vanilla beans | 1,000 | 2.59 | — |
| Insert | | | |
| Extract Yield | 1,000 | 1.87 | 72 |

6. Calculations

Total vanillin (%)=Vanillin (%)+0.48*Glucovanillin (%)

Molar mass vanillin: 152.14 g/mol

Molar mass glucovanillin: 314.29 g/mol

Molar mass ratio vanillin/glucovanillin=0.48

Transformation rate=conversion of glucovanillin to vanillin;

Transformation rate=vanillin (%) after fermentation/(0.48*glucovanillin (%) before fermentation)

Vanillin recovery (vanillin yield)=vanillin contained in the dried fermented vanilla beans, relative to the total vanillin originally contained in the green vanilla beans.

7. Method of Analysis

Analyses for vanillin and glucovanillin content were carried out by means of high-pressure liquid chromatography (HPLC).

### Sample Preparation:

The sample was weighed into a 10 ml volumetric flask or 100 ml volumetric flask and made up to volume with ethanol 25% (v). The sample solution was then filtered through a syringe filter (0.45 μm).

### HPLC Parameters:

Device: Jasco U-HPLC Model XLC with DAD/RI

Column: Kinetex 2.6μ C18 100 A (100×2.1 mm)

Mobile phase: Phase A: buffer NaH₂PO₄ (pH 2.5)+5% acetonitrile
Phase B: Acetonitrile

Flow rate: 0.2 ml/min (gradient); temperature: 40° C.; injection volume: 5.0 μl; detector: DAD, 270 nm

1. A method for the preparation of dried fermented spice plant part particles comprising:
(a) providing freshly harvested spice plant parts;
(b) breaking up the freshly harvested spice plant parts;
(c) freezing the broken up spice plant parts;
(d) defrosting the frozen broken up spice plant parts;
(e) drying the defrosted broken up spice plant parts in a closed system to obtain dried fermented spice plant part particles; and
(f) optionally, breaking up the dried fermented spice plant particles.

2. The method according to claim 1, wherein the freshly harvested spice plant parts are selected from one or more in the group consisting of vanilla beans, tea leaves, clove buds, tonka beans, pepper fruits, coffee beans, cocoa tree seeds, saffron threads, ginger, turmeric, capers, aniseed, nutmeg, paprika, and petals.

3. The method according to claim 1, wherein the freezing of the broken up spice plant parts takes place at a temperature in a range of −1° C. to −80° C.

4. The method according to claim 1, wherein freezing of the broken up spice plant parts is carried out over a period of at least 1 day and/or wherein thawing of the frozen spice plant parts is carried out over a period of at least 1 day.

5. The method according to claim 1, wherein the drying of the thawed broken up spice plant parts is carried out at a temperature in a range of 20° C. to 70° C.

6. The method according to claim 1, wherein the drying of the thawed broken up spice plant parts is carried out in one or more apparatus selected from a heat pump condensation dryer, heating cabinet, infrared dryer, circulating air oven, and convection heat oven.

7. The method according to claim 5, wherein the drying of the thawed broken up spice plant parts is carried out under air circulation for a period of at least 5 hours.

8. The method according to claim 1, comprising breaking up the dried fermented spice plant particles wherein the dried fermented spice plant part particles are vanilla pod particles, wherein the yield of vanillin is at least 70% based on the total vanillin content originally present in the freshly harvested spice plant parts which are green unfermented vanilla pods as vanillin precursor and vanillin.

9. The method according to claim 1, further comprising
(g) collecting a condensate-water phase from drying step (e); and
(h) recovering flavouring substances contained in the condensate-water phase.

10. The method according to claim 9, wherein the recovery of the flavouring substances from the condensate-water phase comprises:
(i) providing the condensate-water phase containing flavouring substances;
(ii) providing an adsorption material;
(iii) passing the condensate-water phase from step (i) through a device containing adsorption material from step (ii) with adsorption of the flavouring substances on the adsorption material;
(iv) providing at least one food-grade organic solvent or a solvent mixture comprising at least one food-grade organic solvent;
(v) stripping the flavouring substances from the adsorption material from step (iii) with the at least one solvent or solvent mixture from step (iv) to obtain a flavour extract; and
(vi) optionally, concentrating the flavouring extract obtained from step (v).

11. The method according to claim 10, wherein the spice plant part particles are vanilla pod particles, in which the yield of flavouring substances from the condensate-water phase is 0.1 to 20% based on the content of flavouring substances and precursors thereof originally present in the freshly harvested spice plant parts which are green unfermented vanilla pods.

12. Dried fermented spice plant part particles obtainable by the process according to claim 1.

13. Flavouring extract obtainable by the process according to claim 9.

14. Dried fermented vanilla bean particles, wherein the yield of vanillin is at least 70% based on the total vanillin content originally present in green unfermented vanilla beans as vanillin precursor and vanillin and/or the dried fermented vanilla bean particles comprise a vanillin content of at least 1.5% vanillin based on dry substance.

15. The method of claim 1, wherein the spice plant part particles are vanilla bean particles and further comprising:
(i) breaking up the dried fermented vanilla bean particles;
(ii) providing at least one food-grade extraction solvent or an extraction solvent mixture comprising at least one food grade extraction solvent
(iii) treating the vanilla bean particles with the extraction solvent of the extraction solvent mixture to prepare an extract;
(iv) filtering the extract to remove solids; and
(v) optionally, concentrating the obtained vanilla extract.

16. The method according to claim 15, further comprising:
(vi) drying the filtered extracted dried fermented vanilla pod particles from step (iv); and
(vii) optionally, grinding the extracted dried fermented extracted vanilla bean particles to obtain extracted vanilla powder.

17. Vanilla extract obtainable by the process according to claim 15.

18. The method according to claim 16, further comprising adding to the extracted vanilla powder an aroma extract, is added according to claim 9.

19. Vanilla extract according to claim 17, in which the yield of vanillin is at least 60% based on the total vanillin content originally present in the green unfermented vanilla beans as vanillin and vanillin precursor.

20. A vanilla extract according to claim 17, wherein the aroma profile on a scale of 0 to 10 points of a conventional panel profile deviates by at least 1 point in the olfactory axis “phenolic” and by at least 2 points in the olfactory axes “balsamic” and “vanilla bean”, the aroma profile being measured via a test panel wherein descriptors are first defined for a panel of at least ten trained test persons, who test the samples based on a coded randomised sequence in a sensory room without foreign odours and the final results are determined by summing the individual results and then forming the arithmetic mean for each descriptor.

21. Extracted vanilla powder obtainable by the process according to claim 15.

22. Use of the dried fermented spice plant part particles according to claim 12 for the preparation of foodstuffs, semi-luxury foods, beverage products, semi-finished products, hygiene products, tobacco products, cosmetic or pharmaceutical products, or products for animal nutrition.

23. Food, luxury food, beverage products, semi-finished products, hygiene products, tobacco products, cosmetic or pharmaceutical products and products for animal nutrition, comprising dried fermented spice plant part particles according to claim 12 and wherein the food is selected from the group consisting of dairy products, sweets, dietary supplements, dietary foods and food surrogates.
